(19) United States
(12) Patent Application Publication
(10) Pub. No.: US 2006/0150714 A1
(43) Pub. Date: Jul. 13, 2006

(54) Method and equipment for measuring vapour flux from surfaces

(76) Inventor: Robert Erich Imhof, Kent (GB)

Correspondence Address: Ronald B Sherer, 103 South Shaffer Drive, New Freedom, PA, 17349, US

(21) Appl. No.: 10/530,780

(22) PCT Filed: Oct. 8, 2003
(86) PCT No.: PCT/GB03/04365

§ 371 Date: Apr. 7, 2005

(30) Foreign Application Priority Data
Oct. 8, 2002 (GB) 0223274.2

(51) Int. Cl. G01N 7/00

(52) U.S. Cl. 73/29.01

(57) ABSTRACT

Equipment and a method for measuring water vapour flux from a surface such as skin uses a closed measuring chamber in which there is a means for agitating the air within the measuring chamber to give improved measurements.

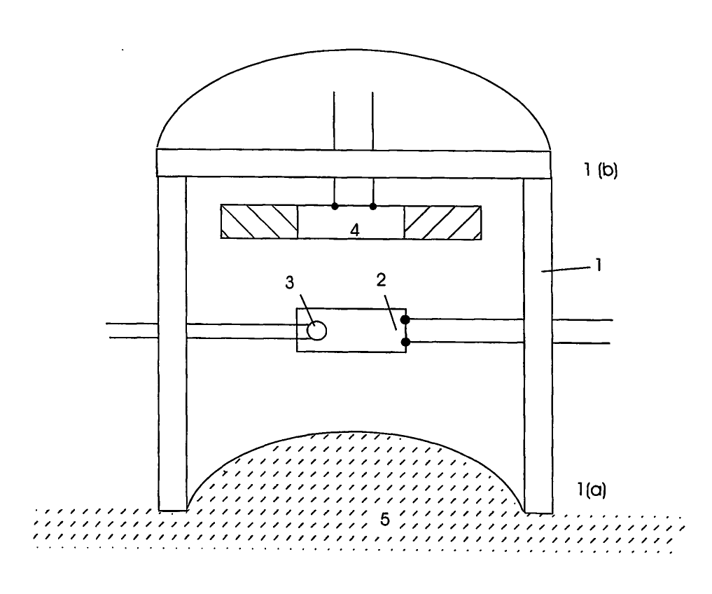

The present invention relates to a method and a device for measuring vapour flux from a surface; more particularly it relates to a method and a device which can be used to measure the rate of transepidermal water loss (TEWL) from human skin.

TEWL is important in the evaluation of the efficiency of the skin-water barrier. Damage to the skin resulting from various skin diseases, burns and other causes can affect the TEWL and measurement of the TEWL can indicate such damage and possibly its early onset or response to treatment. It therefore has a use in clinical diagnosis.

As the TEWL is a measure of the effectiveness of the skin-water barrier, its measurement is important in assessing skin damage caused by interaction with external substances including soaps, detergents and industrial chemicals. Prematurely born infants do not have a fully formed stratum corneum and TEWL measurements can monitor its formation and warn of dehydration due to excessive water loss. TEWL is also used more generally in testing the effect of pharmaceutical and cosmetic products applied to the skin.

TEWL measurement is a special case of the more general problem of measuring the water vapour flux density emanating from a small area of surface (the test surface). Equipment and methods for measuring this quantity can conveniently be divided into two categories, namely:

(i) Time-series methods that can measure water vapour flux density and changes in this quantity over prolonged periods of time. Time series methods include the open chamber diffusion gradient method (Nilsson, GB patent 1532419), flowing gas methods such as manufactured by Skinos Co Ltd, Japan and the closed chamber condenser method (Imhof, PCT/GB99/02183, 1999). Time-series methods all incorporate a means of preventing the accumulation of water vapour from the test surface within their measurement chambers, this being an essential requirement for continuous measurement over a prolonged period of time.

(ii) Single-value methods that can only measure water vapour flux density for a short interval of time, typically of the order of one minute depending on the size of the measurement chamber. These methods use closed measurement chambers in which the water vapour emanating from the test surface is trapped without any means of escape or removal. At the end of the measurement, the water vapour that has accumulated in the measurement chamber needs to be removed in some way before the next measurement can be attempted. Single-value methods include the Vapometer manufactured by Delfin Technologies Ltd, Finland (PCT/WO 01/35816 A1), the instrument described by Tagami et al (Skin Research & Technology, Vol. 8, pp 7-12, 2002) and the dynamic porometer such as the instrument manufactured by Delta-T Ltd, UK.

The measurement chambers of the single-value methods cited in (ii) above need to be purged to remove any water vapour accumulated during a previous measurement. This can be done by injecting a small quantity of dry gas prior to a measurement, as in the dynamic porometer of Delta-T Ltd, UK, for example. This method of purging has the disadvantages of size, weight and complexity associated with the gas purging system. Another method, used with the Vapometer manufactured by Delfin Technologies Ltd for example, is to move the measurement wand incorporating the measurement chamber rapidly through ambient air, such movement causing the measurement chamber to be purged through turbulent mixing with ambient air. This has the disadvantage of lack of control and reproducibility.

We have now devised an improved method for purging the measurement chamber of a single-value method of water vapour flux measurement, which method reduces or overcomes the disadvantages of the purging methods cited above.

This present invention relates to a single-value method for measuring water vapour flux, and equipment for carrying out this method which offers advantages over the prior art represented by the three single-value methods cited in (ii) above. All three above methods use a closed measurement chamber to collect water vapour emanating from the test surface. The present invention similarly uses a closed chamber. The main difference is that the measurement chamber of the present invention incorporates an active means for agitating the air within it. The main purpose of this agitator is to purge the measurement chamber when its measurement face is not in contact with the test surface and the chamber is open to ambient air. Purging with ambient air can occur before, after or both before and after each measurement, to provide reproducible conditions for each measurement.

The agitator can also be active during the measurement itself while the measurement face is in contact with the test surface. This causes the water vapour emanating from the test surface to be mixed rapidly with the trapped air to produce a vapour-air mixture of near-uniform humidity and temperature. This eliminates delays and non-uniformities associated with unassisted, passive mixing, making the measurement less sensitive to the positioning of the sensors and simplifying the mathematical model for calculating water vapour flux density. Such an agitated closed-chamber measurement method has been used to measure evaporative water loss from abdominal cavities during surgery, for example (L.-O Lamke, G. E. Nilsson and H. L. Reithner, Acta Chir Scand, 143, 279-84, 1977).

According to the invention there is provided a method for measuring single values of vapour flux density from a test surface, which method comprises purging the measurement chamber by means of an agitator incorporated within it before and/or after each measurement to ensure reproducible conditions for the measurement, (i) placing the open end of the measurement chamber, with a single opening at one end, against the test surface and (ii) measuring the parameters from which the flux density of vapour entering the chamber can be determined in which the measurement chamber is purged by means of an agitator incorporated within it before and/or after each measurement to ensure reproducible conditions for the measurement, The air in the measurement chamber may or may not be agitated during the measurement itself, but it is argued that agitation during the measurement is beneficial.

The invention also provides equipment for measuring water vapour flux density from a surface which equipment comprises (i) a measurement chamber with a single opening at one end, which opening is adapted to be placed against the test surface, (ii) an air agitating means positioned within the measurement chamber and (iii) a means to measure the water vapour density within the chamber.

The means to measure the water vapour density within the chamber can be sensors positioned within the chamber which are able to measure quantities from which the density of water vapour within the chamber can be calculated. The quantities from which the density of water vapour can be determined include relative humidity and temperature etc. The sensors need not be deployed wholly inside the measurement chamber. Deployment on the outside of the measurement chamber, as described in Patent Application PCT/GB 2003/000265, may be more convenient.

Alternative means of measuring water vapour density in the measurement chamber can be used such as a sensor based on measuring the absorption of infrared radiation of suitable wavelength by the water vapour. If the temperature of the air within the measurement chamber remains nearly constant throughout a measurement sequence, then the temperature sensor within the measurement chamber may be dispensed with.

Preferably the air agitation means is a mechanical device such as a fan; however alternative means of agitating the air in the measurement chamber can be deployed, with the motive power supplied by electrical, pneumatic or other means, providing rotary, reciprocating or other motion to an agitator propeller or paddle. The source of motive power can be situated either inside or outside the measurement chamber. If the source of motive power is situated on the outside of the measurement chamber, then it can conveniently be coupled to the agitator inside the measurement chamber by means of a shaft, electromagnetic or other form of coupling.

In use, the open end of the equipment is placed against the test surface, e.g. skin. The agitation of the air may be active before contact is made with the test surface, so that the chamber is purged with ambient air immediately before the measurement. The sensor readings from which the density of the water vapour and hence the flux density can be determined are then made. During these measurements, the agitation of the air within the chamber is preferably active, to mix it with the water vapour emanating from the test surface to near-uniform properties of humidity and temperature. When the measurement is finished, the agitation of the air in the measurement chamber needs preferably to be active, so that the chamber is purged of the water vapour accumulated during the measurement.

The readings from the sensors of typically relative humidity and temperature can be used to calculate the density of water vapour within the measurement chamber. The agitation ensures that the water vapour from the test surface is actively and rapidly mixed with the air enclosed in the measurement chamber and that the vapour density is therefore uniform throughout. The positioning of the sensors within the measurement chamber is therefore not critical.

If uniform mixing of the water vapour entering the measurement chamber from the test surface and the air trapped within it is assumed, the water vapour flux density emanating from the test surface can be calculated from the rate of increase of water vapour density in the measurement chamber using Eq.(1)

$$J = \frac{V}{A} \cdot \frac{\partial ρ}{\partial t} \qquad Eq . ( 1 )$$

where J is the water vapour flux density
V is the volume of the measurement chamber
A is the open area of the measurement chamber in contact with the test surface
ρ is the water vapour density within the measurement chamber

The assumption made in the derivation of Eq.(1) is that the water vapour emanating from the test surface would remain as water vapour within the measurement chamber. This condition is satisfied as long as (a) the relative humidity everywhere within the measurement chamber remains below 100%, and (b) the materials within the measurement chamber which come into contact with water vapour are not hygroscopic. If condition (a) is not satisfied, then condensation of water vapour to liquid water may occur. It is therefore important to ensure that the measurement is terminated and the measurement chamber is removed from the test surface well before such saturation conditions are reached. If condition (b) is not satisfied, then a quantity of water vapour may be lost temporarily through surface adsorption. Conversely, previously adsorbed water may be desorbed when the humidity in the measurement chamber is low. These processes may lead to measurement errors such as “memory effect” or hysteresis.

According to Eq.(1), the water vapour flux density can be calculated from the rate of increase of water vapour density in the measurement chamber. If the flux density is constant, then this rate of increase is constant. It can then be calculated, for example, from the difference between two vapour density values calculated from readings taken at two separate times, or from a least-squares calculation to a series of vapour density values calculated from readings taken over an appropriate time interval. Changes of water vapour flux density during a measurement manifest themselves as changes of the rate of increase of water vapour density in the measurement chamber.

Eq.(1) is not specific to any particular geometry of measurement chamber or deployment of sensors within it Therefore any convenient shape can be used e.g. cylindrical, rectangular parallelepiped, prism, etc. However, its main dimensions of volume V, and open area A in contact with the test surface are important parameters that can be adjusted to a particular measurement application. The parameter A is the area of test surface over which the mean flux density is calculated. The ratio A/V determines the sensitivity of measurement In addition, A/V is inversely proportional to the length of time taken before saturation conditions are approached and therefore the maximum duration of the measurement for a given value of flux density.

A suitable and convenient method of measuring the density of water vapour within the measurement chamber is by using common sensors of relative humidity and temperature, the two sensors acting together to measure these two properties at essentially the same location. A suitable and convenient choice of relative humidity sensor includes those based on a change of capacitance or a change of electrical conductivity etc, which are widely commercially available. A suitable and convenient choice of temperature sensor includes the conventional thermocouple and thermistor, which are widely commercially available. Alternatively a composite sensor can be used which simultaneously measures relative humidity and temperature so that one such composite sensor can produce the required signals.

The water vapour density can be calculated from measured values of relative humidity and temperature using the well known relationship

$$ρ = \frac{RH \%}{100} \cdot {ρ}_{S} ( θ ) \qquad Eq . ( 2 )$$

where RH% is the percentage relative humidity
θ is temperature
ρₛ is the saturation vapour density

The saturation vapour density can conveniently be computed from an empirical parameterisation such as that of P. R. Lowe, (J. Appl. Meteorol., Vol. 16, pp 100-3, 1977).

In use, the open end of the measurement chamber is placed against the test surface and a start-signal is sent to the processor to initiate a measurement sequence. This start-signal is conventionally and conveniently generated manually by the user actuating a switch such as a push-button on the handle of the measurement wand or a foot switch. Alternatively, an automatic means of generating a start-signal can be deployed. One example is to sense the increase of relative humidity or vapour density in the measurement chamber against a reference value provided by similar sensors used for measuring ambient conditions. Another example is to deploy a light sensor such as a photodiode in the measurement chamber to generate a start-signal when the light level decreases below a pre-set value, as the measurement chamber makes contact with the test surface.

Once the start-signal has been received, readings from the sensors are taken periodically by a processor in order to record the time change of the signals. The measurement sequence is terminated and the contact between the measurement chamber and the test surface is broken after a predetermined criterion or set of criteria are satisfied. Most importantly, the measurement must be terminated when the relative humidity within the measurement chamber reaches a pre-determined level. This level is chosen to be high enough to allow the measurement to be taken but low enough to prevent condensation from occurring. Other criteria that can be used to terminate a measurement in advance of this include a pre-set measurement time or a pre-set measurement precision.

The invention is described with reference to the accompanying drawing which is a side view of an embodiment of equipment according to the invention.

In the drawing a measurement chamber in the form of a hollow cylinder (1) is open at end (1a) and is closed at the end (1b). The measurement chamber material is preferably a dense plastic or other material that does not absorb or adsorb significant quantities of water. Inside the cylinder (1) are a capacitative relative humidity sensor (2) and a thermistor (3) that measure the relative humidity and temperature at substantially the same location. The outputs of (2) and (3) are fed to a computer (not shown). Also inside the cylinder is a small fan (4) to agitate the air and cause uniform mixing of the enclosed water vapour and air.

To measure the water vapour flux density from the test surface (5) such as the skin of a person, the open end (1a) is placed against the skin, so that the measurement chamber becomes closed trapping air which mixes with vapour from the skin. At the same time as the measurement chamber makes contact with the test surface or immediately afterwards, a start-signal is sent to the computer to initiate a measurement sequence. The means by which this start-signal is generated is not shown. The computer is programmed with a program so that the output from the sensors (2) and (3) are converted to a reading in the desired form, e.g. water vapour flux density from the surface. A graphical representation of the readings or quantities derived from the readings may also be used to verify that the underlying assumptions hold true and that the measurement is valid. The fan (4) can be operated whilst the measurements by the capacitative relative humidity sensor (2) and a thermistor (3) are taken to ensure that the vapour is mixed rapidly with the trapped air to produce a vapour-air mixture of near-uniform humidity and temperature.

After a measurement and before the humidity within the measurement chamber has increased to a value where condensation might occur, the contact between the chamber and the test surface is broken and ambient air is mixed with the previously trapped air with the help of the fan (4), in order to restore the humidity and temperature conditions within the measurement chamber to those of ambient air.

In the implementation described, only one relative humidity sensor and one temperature sensor is required, thus simplifying the construction. This does not preclude the use of more sensors, however. The use of additional sensors would allow more precise calculations of water vapour flux density to be performed, if the distribution of water vapour within the measurement chamber were not perfectly uniform. It may also be convenient to incorporate additional sensors in the equipment outside the measurement chamber, to measure ambient temperature, ambient humidity, skin temperature, etc.

The measurement chamber can conveniently be incorporated in a hand-held wand or with a convenient handle etc.

The equipment and method can be used to measure any vapour flux density from a test surface although, when the vapour is not water vapour, the sensors are chosen accordingly.

The equipment and method can be used with any test surface. Apart from skin, the equipment can be used to measure water vapour flux from plant leaves, etc. The cylinder is the common geometry of measurement chamber for such instruments, but any convenient shape can be used, e.g. rectangular parallelepiped, prism, etc.

1. Equipment for measuring water vapour flux density from a surface which equipment comprises (i) a measurement chamber with a single opening at one end, which opening is adapted to be placed against the test surface; (ii) an air agitating means positioned within the measurement chamber and (iii) a means to measure the water vapour density within the chamber.

2. Equipment as claimed in claim 1 in which the air agitating means within the chamber is able to purge the chamber with ambient air before and/or after each measurement.

3. Equipment as claimed in claims 1 and 2 in which the air agitation means within the measurement chamber is a mechanical device.

4. Equipment as claimed in claims 1 to 3 in which the air agitation means comprises a fan.

5. Equipment as claimed in claims 1 to 4 in which the motive power for the air agitating means in the measurement chamber is supplied by electrical, pneumatic or other means, providing rotary, reciprocating or other motion to an agitator propeller or paddle.

6. Equipment as claimed in claims 1 to 5 in which the source of motive power is situated either inside or outside the measurement chamber and, if the source of motive power is situated outside the measurement chamber, then it is coupled to an agitator inside the measurement chamber by means of a shaft, electromagnetic or other form of coupling.

7. Equipment as claimed in claims 1 to 6 in which the means to measure the water vapour density within the chamber comprise sensors positioned within the chamber or outside it, which sensors are able to measure quantities from which the density of water vapour within the chamber can be calculated.

8. Equipment as claimed in claims 1 to 7 in which the sensors comprise means to measure the relative humidity and, optionally the temperature within the chamber.

9. Equipment as claimed in claims 1 to 7 in which there are a plurality of sensors.

10. Equipment as claimed in claims 1 to 6 in which the means to measure the vapour density within the chamber comprises a sensor based on measuring the absorption of infrared radiation of suitable wavelength by the vapour.

11. Equipment as claimed in any one of the preceding claims equipped with sensors able to measure the density of a vapour other than water vapour, which sensor readings can be evaluated to measure the flux density of the said vapour.

12. Equipment as claimed in any one of the preceding claims in which there are means whereby the start of the measurement can be triggered either manually by the operator, or automatically by means of additional sensors.

13. Equipment as claimed in any one of the preceding claims in which the measurement chamber is incorporated in a hand-held wand or other convenient hand-held enclosure.

14. A method for measuring vapour flux density from a surface which method comprises placing the open end of a measurement chamber with a single opening at one end against the surface, optionally agitating the air within the chamber and measuring changes of vapour flux density within the chamber.

15. Method as claimed in claim 14 whereby the said measurement chamber is purged with ambient air before and/or after each measurement by an agitation means incorporated within the chamber.

16. Method as claimed in claims 14 to 15 whereby the said measurement chamber is equipped with sensors and the rate of rise of water vapour density within it determined, which rate of rise is used to calculate water vapour flux density and related quantities such as water vapour flux, TEWL, stomatal conductance etc.

17. Method as claimed in claims 14 to 16 whereby the start of the measurement is triggered either manually by the operator, or automatically by means of additional sensors.

18. Method as claimed in claims 14 to 17 in which the vapour flux of water vapour is measured.

19. Method as claimed in claims 14 to 16 in which the vapour flux of vapours other than water vapour is measured, and the appropriate sensors for the given vapour are used.

20. Method as claimed in any one of claims 14 to 19 in which the vapour is mixed rapidly with the trapped air to produce a vapour-air mixture of near-uniform humidity and temperature.

21. Equipment for measuring water vapour flux density from a surface which equipment comprises:
(i) a measurement chamber with a single opening at one end, which opening is adapted to be placed against the test surface;
(ii) an air agitating means positioned within the measurement chamber; and
(iii) a means to measure the water vapour density within the chamber.

22. Equipment as claimed in claim 21 in which said air agitating means within the chamber is able to purge the chamber with ambient air before and/or after each measurement.

23. Equipment as claimed in claim 21 in which said air agitation means within the measurement chamber is a mechanical device.

24. Equipment as claimed in claim 21 in which said air agitation means comprises a fan.

25. Equipment as claimed in claim 21 including motive power means comprising electrical, pneumatic or other means for providing rotary, reciprocating or other motion to fluid mixing means comprising a propeller or paddle.

26. Equipment as claimed in claim 25 in which said motive power means is outside of the measurement chamber and is coupled to said agitator inside the measurement chamber by means of a shaft, electromagnetic or other form of coupling.

27. Equipment as claimed in claim 21 in which the means to measure the water vapour density within the chamber comprise sensor means for measuring quantities from which the density of water vapour within the chamber can be calculated.

28. Equipment as claimed in claim 27 in which at least one sensor comprises means for measuring the relative humidity in the chamber.

29. Equipment as claimed in claim 27 in which there are a plurality of sensors.

30. Equipment as claimed in claim 21 include a sensor for measuring the absorption of infrared radiation of suitable wavelength by the vapour.

31. Equipment as claimed in claim 21 equipped with sensor means for measuring the density of a vapour other than water vapour for measuring the flux density of such vapour.

32. Equipment as claimed in claim 21 including means for starting the measurement manually by the operator or automatically by additional sensor means.

33. Equipment as claimed in claim 21 in which the measurement chamber is incorporated in a hand-held enclosure.

34. Equipment as claimed in claim 27 including sensor means for measuring both the relative humidity and the temperature within the chamber.

35. A method for measuring vapour flux density from a surface which method comprises placing the open end of a measurement chamber with a single opening at one end against the surface, agitating the air within the chamber and measuring changes of vapour flux density within the chamber.

36. A method as claimed in claim 35 including the step of purging said chamber with ambient air before and/or after each measurement.

37. A method as claimed in claims 35 and 36 whereby the said measurement chamber is equipped with sensors and the rate of rise of water vapour density within it determined, which rate of rise is used to calculate water vapour flux density and related quantities.

38. A method as Claimed in claim 35 in which the vapour flux of vapours other than water vapour is measured.

39. A method as claimed in claim 35 including the step of mixing ambient air in the chamber to an extent such as to produce a vapour-air mixture of substantially uniform humidity and temperature.
